(19) United States
(12) Patent Application Publication
(10) Pub. No.: US 2018/0264707 A1
(43) Pub. Date: Sep. 20, 2018

(54) METHOD FOR INHOMOGENEOUS TEMPERATURE CONTROL OF PREFORMS

(71) Applicants: KHS Corpoplast GmbH, Hamburg (DE); Henkel AG & CO. KGaA, Düsseldorf (DE)

(72) Inventors: Alexander SCHILL, Hamburg (DE); Bernhard ORLICH, Düsseldorf (DE); Arne WIESE, Ahrensburg (DE)

(21) Appl. No.: 15/571,229

(22) PCT Filed: Apr. 7, 2016
(86) PCT No.: PCT/EP2016/000568

§ 371 Date: Nov. 1, 2017

(30) Foreign Application Priority Data
May 8, 2015 (DE) 10 2015 005 769.3

(51) Int. Cl. B29C 49/64; B29C 49/62; B29C 49/48; B29C 49/42; B29C 49/06

(52) U.S. Cl. CPC B29C 49/6454; B29C 49/62; B29C 49/48; B29K 2067/003; B29C 49/06; B29C 2049/4226; B29C 49/4205

(57) ABSTRACT

A method for heating a preform that is rotationally symmetric about its longitudinal axis, has a standard thread, and is made of a thermoplastic material. During heating, the preform is temperature conditioned to be formed into a container having a non-circular cross-section transverse to a longitudinal axis of the container by blow-molding. The preform is provided with a temperature profile along a circumference of the preform such that areas of the preform are differentially heated in a radial direction of the circumference of the preform. The standard thread of the preform is aligned in a predefined target position before the areas of the preform are differentially heated. The preform is rotated into alignment. An alignment element engages in the standard thread of the preform and thereby prevents further rotation of the preform as soon as the alignment element comes in contact with a predetermined contact surface in the standard thread.

The invention relates to a method for inhomogeneous temperature control of preforms which are made of a thermoplastic material, wherein the preforms are provided for blow-molding into containers, wherein the preform is provided with a temperature profile which is generated such that areas are differentially heated in the radial direction of the circumference of the preform. The preforms are generally rotationally symmetric about their longitudinal axis. The temperature conditioning of the preforms is accomplished by heating, that is, by the transportation of the preforms through a heating section. During the heating process, the preforms are provided with a temperature profile along a circumference.

Such a method is used, for instance, when preforms are to be manufactured into containers of which the cross-section deviates from a circular form. The deviation might be, for instance, in the production of containers with an oval cross-section, or, for instance, with a triangular or a quadrangular cross-section.

In the forming of a container by way of blow molding, preforms made out of a thermoplastic material, for instance preforms made out of PET (polyethylene terephthalate) are fed to different processing stations inside a blow-molding machine. Typically, such a blow-molding machine comprises a heating device as well as a blowing device, in which the pretempered preform is expanded by means of biaxial orientation into a container. The expansion is accomplished by means of compressed air, which is led into the preform that is to be expanded. The details of the process of this type of expansion of a preform is explained in DE-OS 43 40 291.

The principal construction of a blowing station for container shaping is described in DE-OS 42 12 583. Possibilities for tempering the preforms are explained in DE-OS 23 52 926.

Within the blow-forming device, the preforms and the blow-formed containers can be transported by means of various handling devices. The use of conveyor mandrels onto which the preforms can be pinned has specifically proven itself. However, the preforms may also be handled by other conveyor devices. The use of grippers for the handling of preforms, and the use of expanding mandrels, which can be inserted into the finish area for mounting the preform, also count among the available structures.

The handling of containers involving the use of transfer wheels is described, for instance, in DE-OS 199 06 438 by way of an arrangement of the transfer wheel between a blowing wheel and an output trajectory.

The handling of preforms as previously explained takes place in a so-called two-step process, in which the preforms are initially manufactured in an injection molding process, then put into interim storage, and only later conditioned in terms of temperature and blow-molded into containers, on the one hand. On the other hand, it takes place in a so-called one-step process, in which the preforms are appropriately tempered and blow-molded immediately after their manufacture through injection molding and a after they have sufficiently hardened.

In view of the blowing stations used, a variety of designs is known. In blowing stations arranged on rotating transport wheels, a design often encountered is that of a book-shaped hinged expandability of the form carriers. However, it is also possible to use form carriers that can be moved relative to each other, or that are otherwise carried. In stationary blowing stations that are specifically suitable for absorbing multiple cavities for container forming, plates arranged parallel to each other are typically used by way of form carriers.

The production of such non-circular containers was already described in U.S. Pat. No. 7,775,524. Initially a symmetric temperature control of the preforms takes place, followed by a selective increase of the temperature in selected areas. Other variations of the production of temperature profiles in the radial direction of the circumference of the preform are also described in U.S. Pat. No. 3,632,713, U.S. Pat. No. 3,950,459, and U.S. Pat. No. 3,892,830. Temperature control by way of selective shading is mentioned in DE-OS 33 14 106.

It is known from U.S. Pat. No. 5,292,243 that two preforms can be subjected simultaneously to temperature control in the radial direction of the circumference. EP 0 620 099 contains a compilation of the methods known in prior art for the temperature control of preforms.

Special problems arise when not only a non-circular container is to be blow-molded, but when a screw-on lid for the respective container must also be positioned in a specific orientation with respect to the container, as is the case, for instance, with non-circular spray bottles. A precondition for this is that the already completely finished threads for the screw-on lid on the preform always be in the same orientation, specifically: in the desired orientation, before the preform is given the temperature profile needed for blow-forming, so that after the tempering of the preform, the target alignment of the thread corresponds with the target temperature conditioning of the preform. This is the only way to ensure that after the blow-molding of the container, the screw-on lid will be positioned in the desired orientation respective to the non-circular container.

With respect to the alignment of the preform, it is known that these can be positioned on conveyor mandrels, for instance, and that the conveyor mandrels can be arranged at the entrance into the heating section, for instance by means of protrusions on the conveyor mandrels, which cooperate with an alignment structure along which the conveyor mandrel proceeds along its transportation trajectory. This does not guarantee, however, that the preform is aligned in the desired thread orientation on the mandrel.

One possibility of solving the problem described would be to modify the standard thread of the preform by forming an additional alignment structure in the thread area, which would interact with the alignment element along which the preform is led on its transportation trajectory, for instance at the entrance into the heating section. Together with the alignment of the mandrel as described in the previous paragraph, this would produce the desired alignments, both with respect to the mandrel and with respect to the preform held by it, and to its thread. A disadvantage of this solution is deemed to be that the alignment requires the use of preforms specifically designed for that purpose, which leads to increased costs for the preforms.

The task of the present invention is therefore to indicate a method of the aforementioned type which provides a simple way to align the preforms in the desired manner, and to indicate an alternative to prior art that avoids the aforementioned disadvantages.

This task is solved according to the invention in that in order to align the preform, it is rotated, and in that an alignment element engages the standard thread and prevents the further rotation of the preform as soon as the alignment element comes into contact with a predetermined contact surface in the standard thread. Specifically, it proves to be advantageous to use the venting slots by way of contact surface of the standard thread.

However, it also proves to be advantageous to use the thread intake or the thread runout as a contact surface, as an alternative or in addition. The concept of a standard thread comprises preform threads with a cylindrical base form from which the thread's crests extend radially outward as elevations. The thread's crests feature edge surfaces that are transverse to the direction of the crest, that is, they are oriented in the direction of the longitudinal axis of the preform. Such surfaces in the threadings of standard threads are, for instance, the thread intake, the thread runout, or so-called venting slots which extend in alignment across multiple threadings. Threads that are not deemed to be standard threads are those in which modifications are made for orientation purposes alone, for the creation of orientation structures. The threads referred to in the context of the present application as standard threads are therefore already used with preforms, for instance, that are to be blow-molded into containers with a round cross-section, and for which therefore no alignment in the manner described here is needed. It is specifically the intent of the present invention to be able to use common preforms without modifications in their thread area.

The aforementioned edges are generally shaped at an angle to the surface normal of the cylinder-shaped base form of the preform, which means that the edges are generally not perpendicular in a radial direction on the cylinder surface, but rather at an angle α away from the 90° position, with a preferentially being between 0° and 60°, and further preferentially, between 0° and 45°, and most preferentially smaller than 30°.

The currently common standard threads are, for instance, the PCO 1881 thread, or the PCO 1810 thread. These standard threads are defined by the so-called ISBT (International Society of Beverage Technologists) Thread Finish Review Sub-Committee, www.threadspecs.com, which is a manufacturers' association.

The solution according to the invention accomplishes that no modifications must be made to the preform. The tools for preform manufacturing that are already in use can continue to be used.

Further advantageous embodiments of the invention are indicated in the dependent claims.

In particular, it proves to be advantageous when during the heating process, the preform is held in a rotating carrier element. For these purposes, the preform may, for instance, be pinned onto a conveyor mandrel. This might be done, for instance, in the intake region of the heating section. However, other carrier elements are conceivable as well. It is also conceivable that the carrier element and the preform are only brought together when an inhomogeneous temperature control of the preform is required. It is conceivable, for instance, that the preform is initially heated homogeneously, and that later, in a final segment of the heating section, the desired inhomogeneous heating profile is impressed on it. It is further conceivable that the preform is initially homogeneously heated, and that later, in a timed, loaded, stationary heating element, the desired inhomogeneous heating profile is impressed on it.

The use of carrying elements has the advantage that the carrying elements can be optimized for handling, whereas the preforms can be manufactured in the most economical way in terms of material use, and since handling of the preform itself in the heating section is problematic. In particular, it was taken into account that the carrier element is aligned, and that the preform is aligned as well. If they both have assumed their desired aligned position, they might be mutually connected in a position-stable manner, for instance, as is known from the common clamping mandrel. The desired orientation of the thread will then correlate with the alignment of the carrier element, such that in subsequent processing steps, the alignment of the carrier element also determines the alignment of the preform. Thus, for instance, based on the alignment of the carrier element, the insertion into a blowing station may be accomplished in the desired alignment without a need for paying renewed attention to the alignment of the preform. In particular, consideration was given to the fact that the conveyor mandrel or the different carrier element is inserted into the blowing station together with the preform.

In principle, for the alignment of the preform, the preform itself might be actively rotated. Since preforms are optimized for the use of material and are produced with the lowest possible use of material, it proves to be advantageous when the rotation of the preform is accomplished through the rotation of the carrier element carrying the preform.

The invention will be further explained by means of exemplary embodiments of the invention, in combination with the following figures:

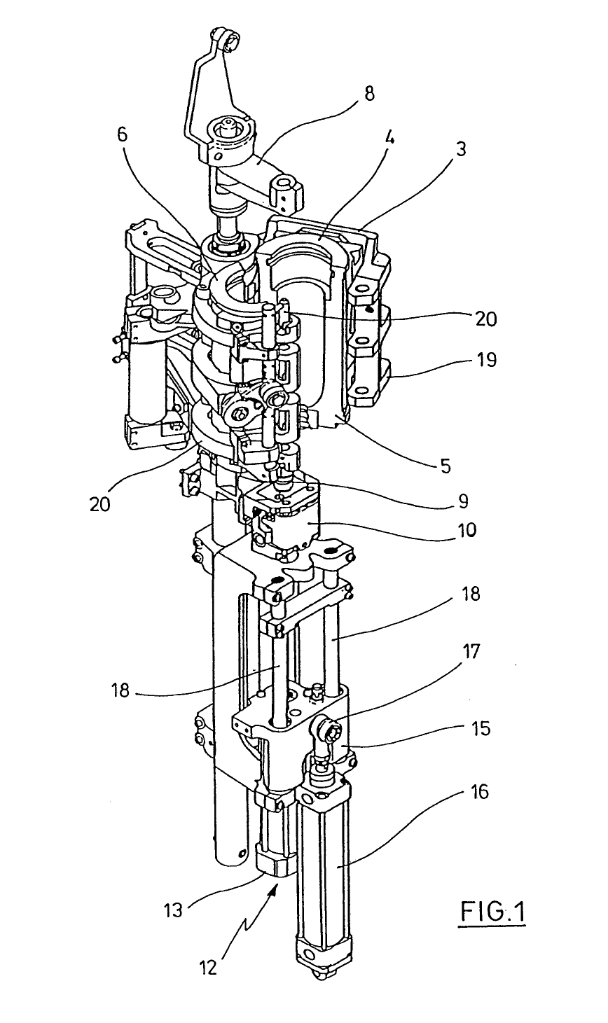

FIG. 1 shows a perspectival view of a blowing station for producing containers from preforms;

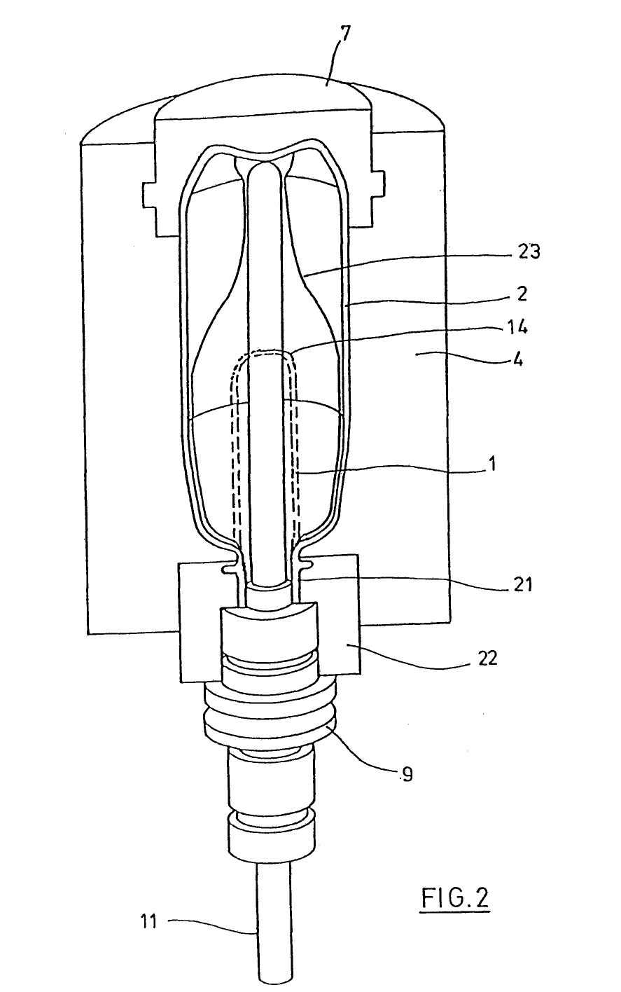

FIG. 2 shows a longitudinal section of a blow mold in which a preform is drawn-out and expanded;

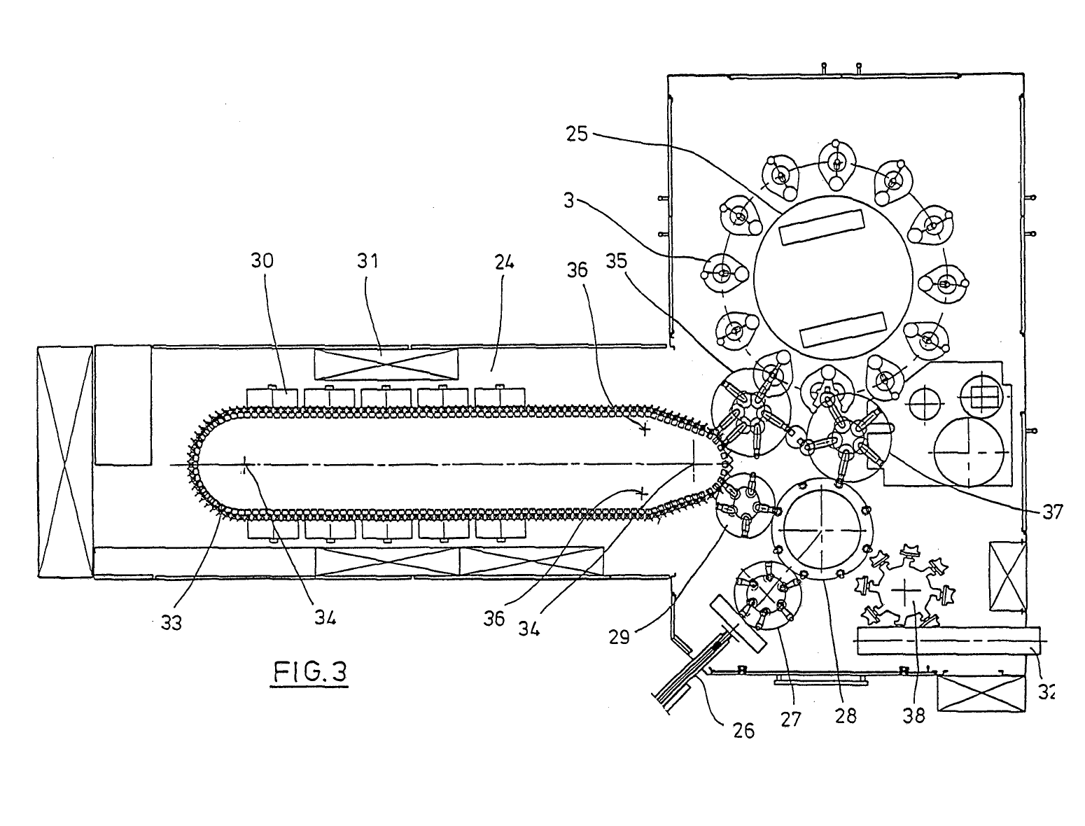

FIG. 3 shows a drawing to illustrate a principal construction of a device for the blow-molding of containers;

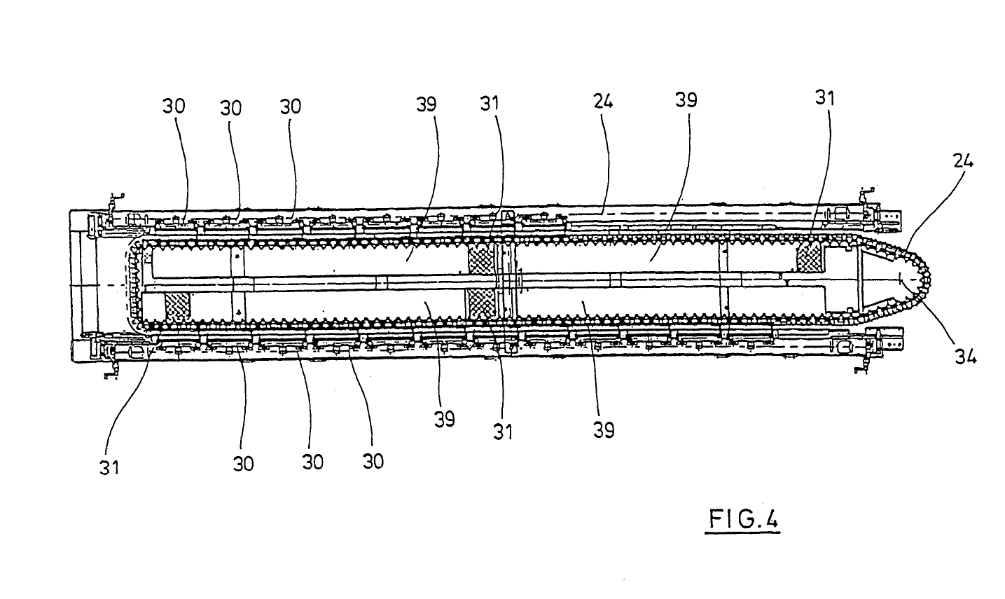

FIG. 4 shows a modified heating section with an increased heating capacity;

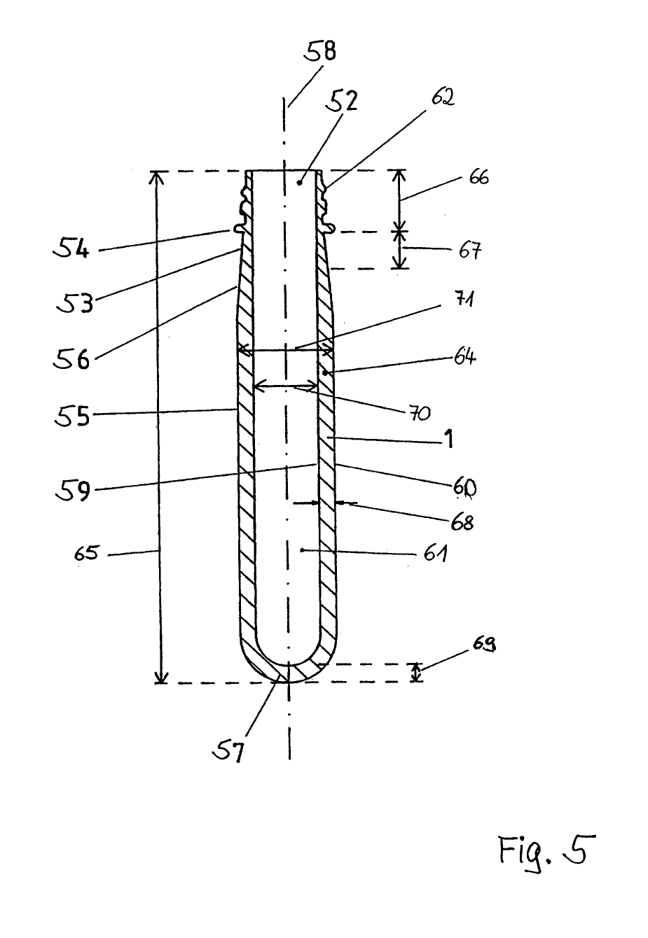

FIG. 5 shows a longitudinal section of a preform;

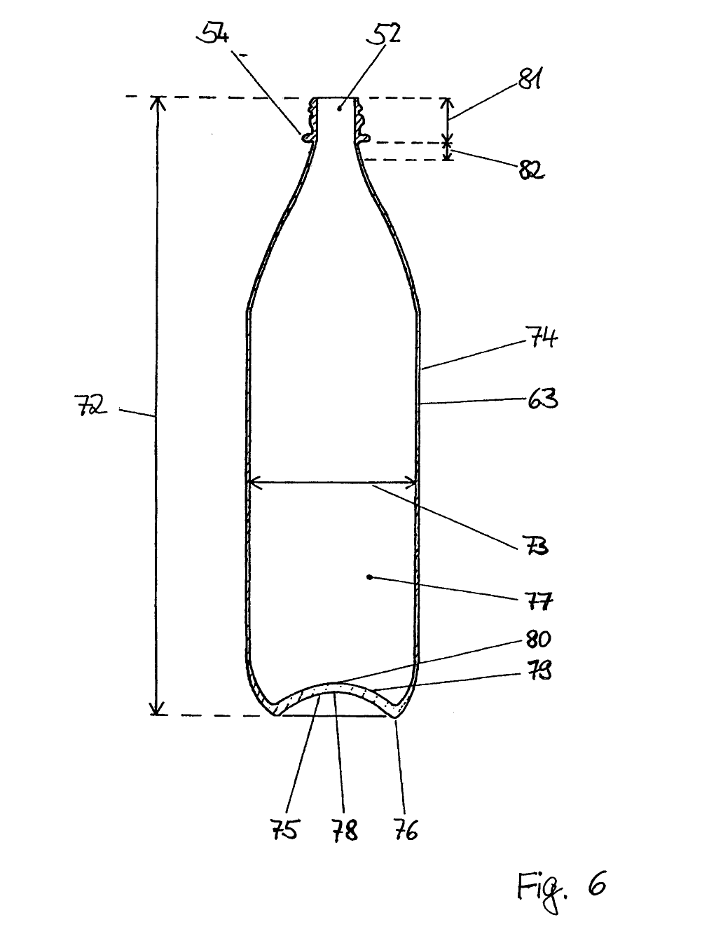

FIG. 6 shows a longitudinal section of a bottle-shaped container;

FIG. 7 shows a top view of a container with an oval cross-section;

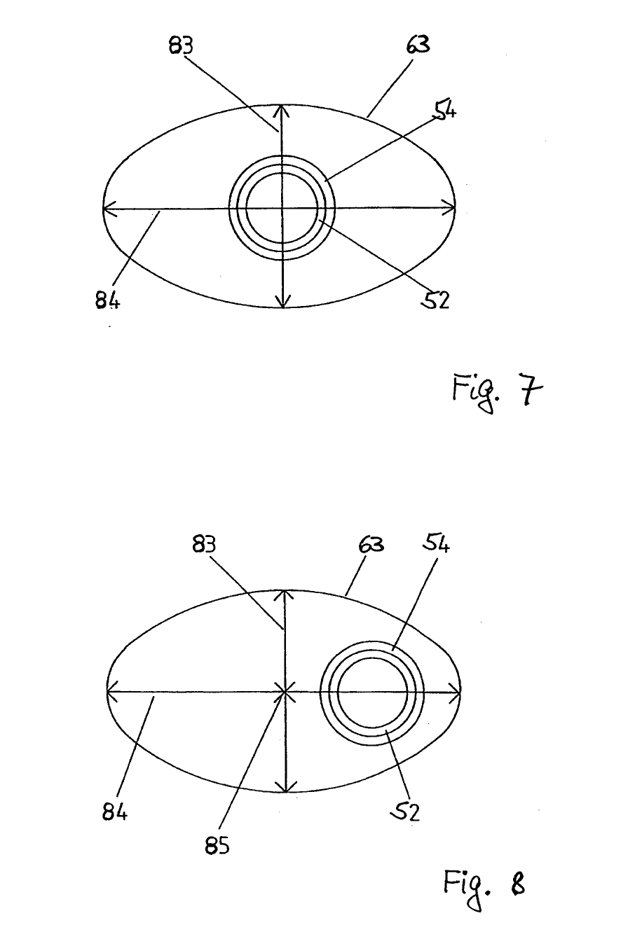

FIG. 8 shows a top view of a container with an oval cross-section and an asymmetrical lip;

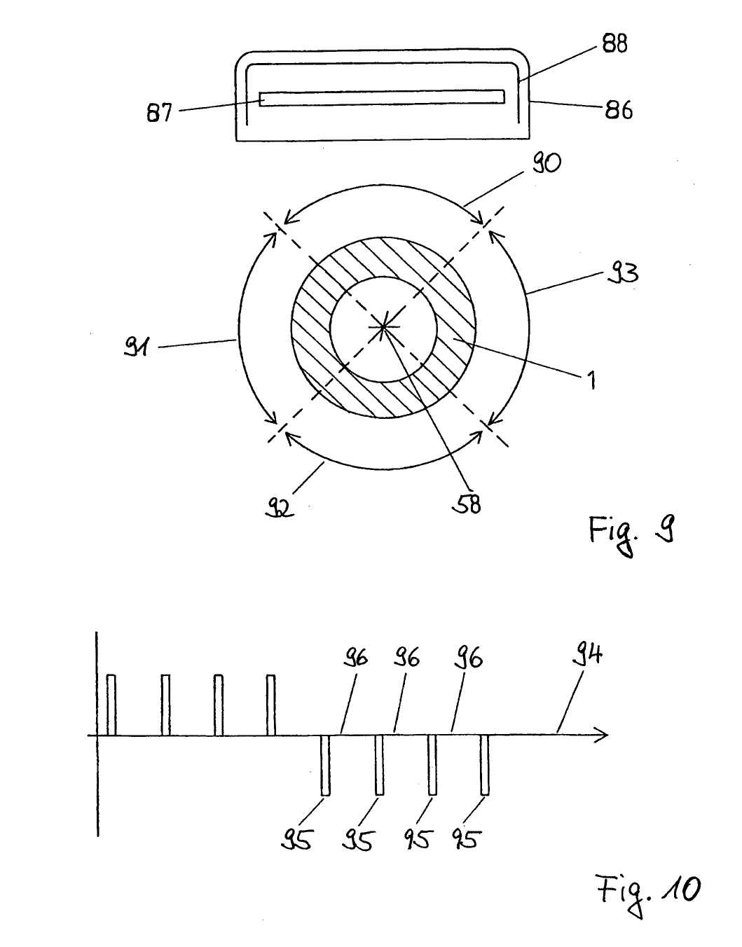

FIG. 9 shows a cross-section of a blow mold in which a container with an oval cross-section is blow-molded;

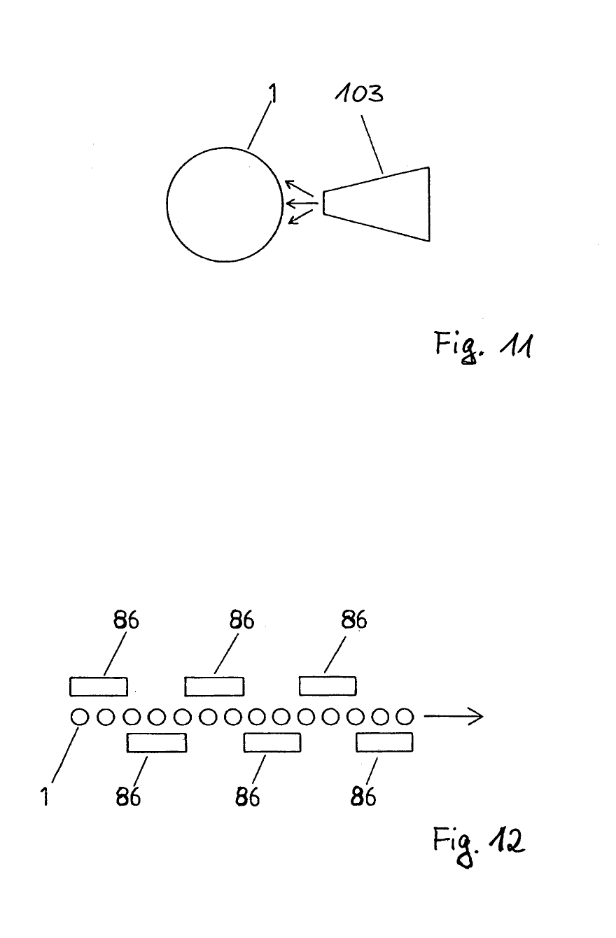

FIG. 10 shows a time diagram for the illustration of the timing of a rotational movement of the preform;

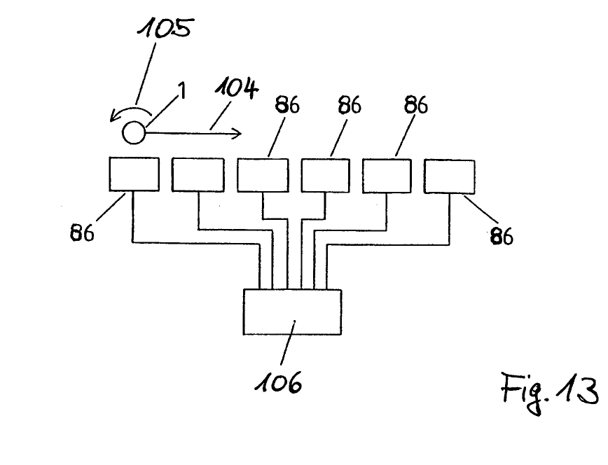

FIG. 11 shows a principal representation in order to illustrate a selective cooling of a preform;

FIG. 12 shows a schematic representation in order to illustrate temperature control of preforms by alternatingly arranged heater boxes with non-rotating preforms;

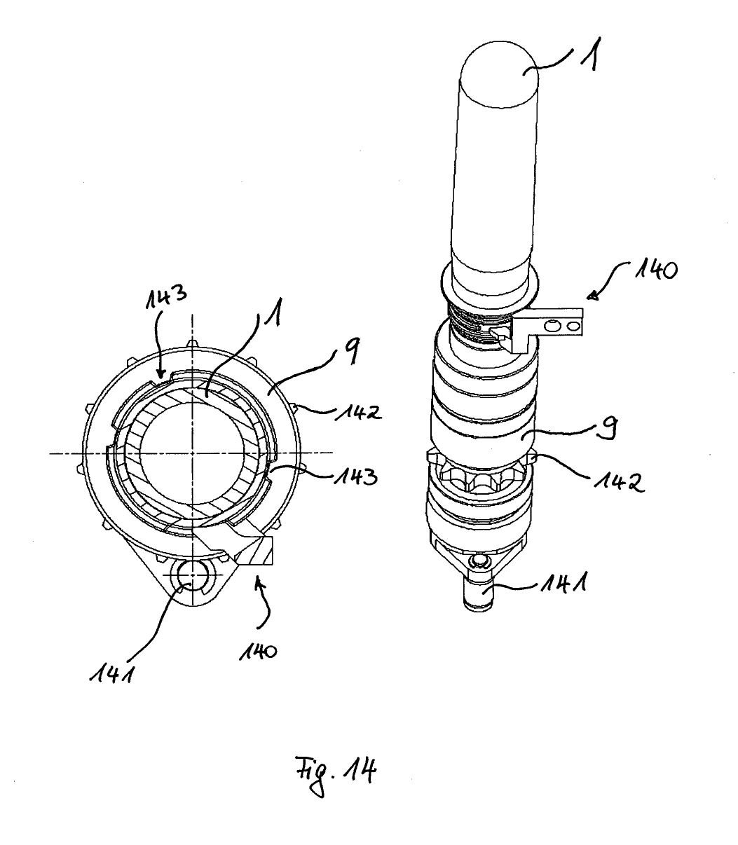

FIG. 13 shows a sketch in order to illustrate temperature control of a preform by variable control of heating devices;

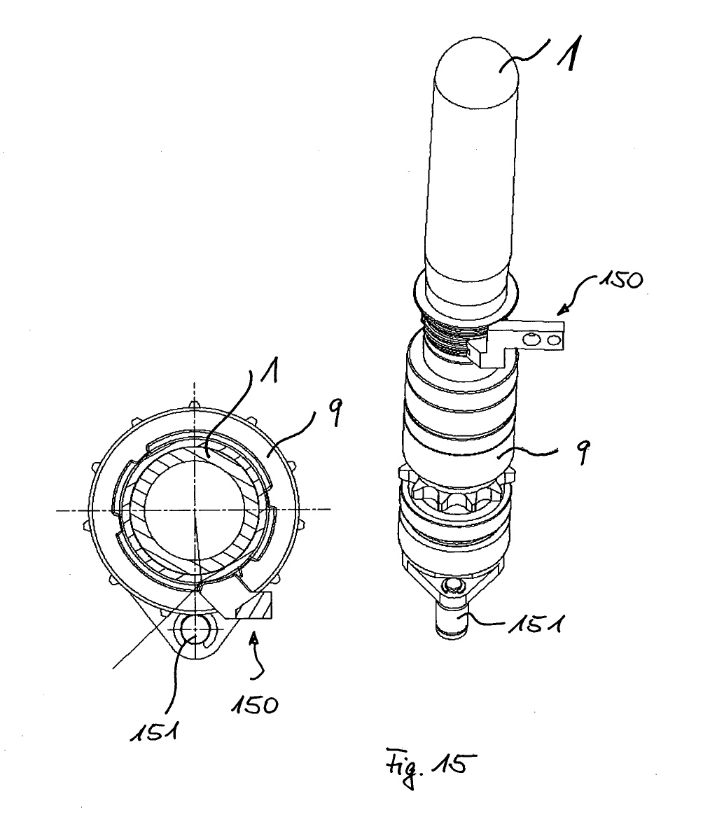

FIG. 14 shows a perspectival view and a cross-sectional view of a preform held by a conveyor mandrel with an alignment element according to a first embodiment;

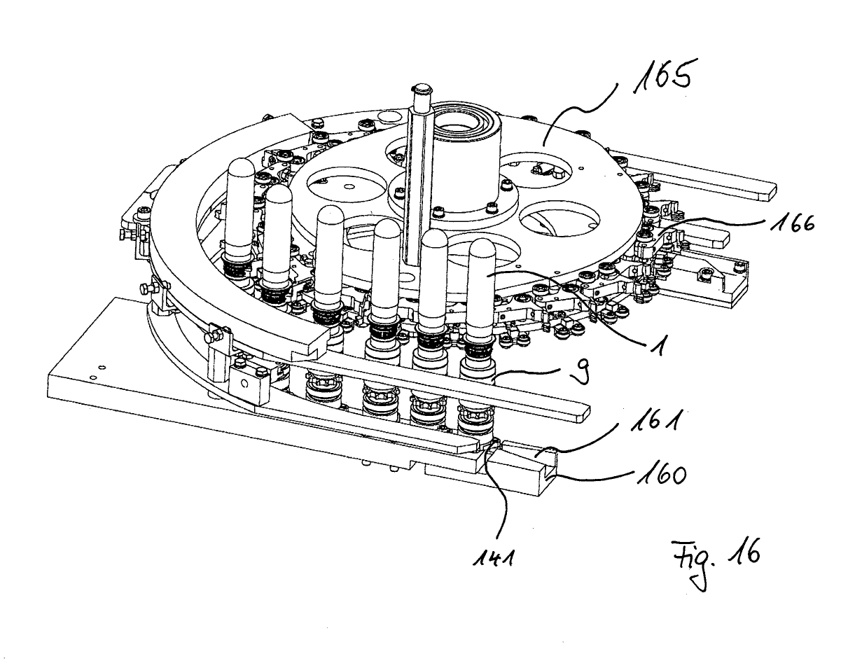

FIG. 15 shows a perspectival view and a cross-sectional view analogous to FIG. 14, with an alignment element according to a second embodiment; and

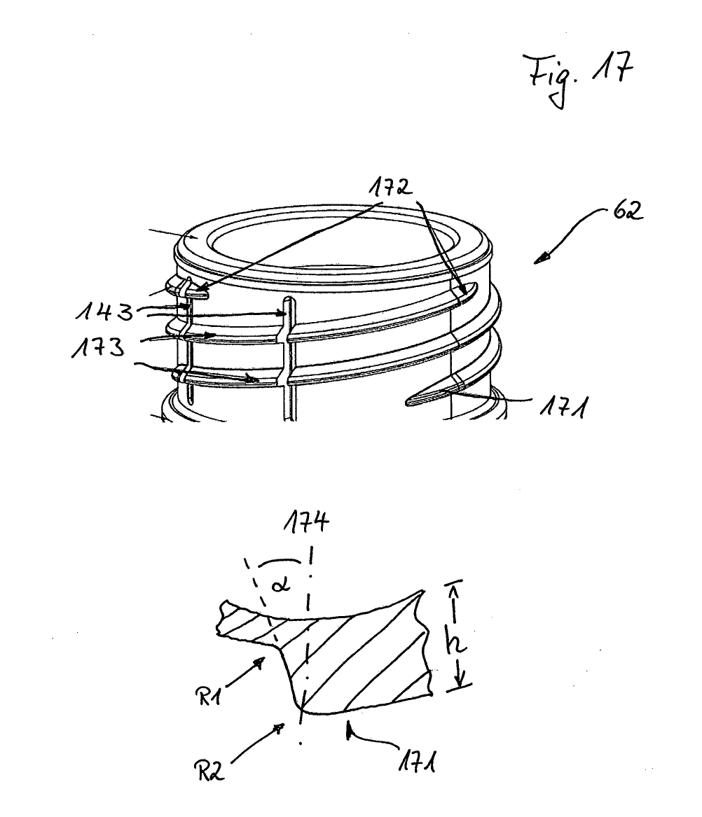

FIG. 16 shows an enlarged view of the intake area of a heating section, with alignment elements for conveyor mandrels and preforms; and

FIG. 17 shows an enlarged view of the thread area of a standard PCO 1881 and a section through the thread area that is perpendicular to the longitudinal axis of the preform at the level of the thread runout.

The principal construction of a device for transforming preforms (1) into containers (2) is shown in FIG. 1 and FIG. 2. Based on these figures, only the principles of the process of blow-molding containers (2) from preforms (1) will be explained.

The described device for forming the container (2) essentially consists of a blowing station (3), which features a blow mold (4), into which a preform (1) can be inserted. The preform (1) may be an injection-molded part made out of polyethylene terephthalate. In order to allow for the insertion of the preform (1) into the blow mold (4) and for the removal of the finished container (2) from it, the blow mold (4) typically consists of mold halves (5, 6) and of a bottom part (7), which can be positioned by means of a lifting device (8), and in the presented example, specifically, it can be lowered and raised. The preform (1) may be held in the area of the blowing station (3) by a conveyor mandrel (9), which passes through a plurality of processing stations within the device together with the preform (1). However, it is also possible that the preform (1) is inserted into the blow mold (4) directly, for instance by means of grippers or other handling elements. In the example shown, the blow-molding is performed on preforms which are positioned with their lips pointing downward. Equally common are blowing stations in which the preforms are positioned with their lips pointing upward.

In order to allow for a compressed air supply, a connection piston (10) is arranged underneath the conveyor mandrel (9), which supplies compressed air to the preform (1) and also performs a sealing function relative to the conveyor mandrel (9). In a modified construction, however, it is also conceivable in principle that firm compressed air leads be used.

The drawing of the preform (1) is done in the present exemplary embodiment by means of a drawing bar (11) positioned by a cylinder (12). According to a different embodiment, the positioning of the drawing bar (11) is accomplished mechanically by means of cam segments which are acted on by tapping rolls. The use of cam segments is particularly expedient when a plurality of blowing stations (3) are arranged on a rotating blow wheel. From prior art, drawing bars with a linear motor drive are known as well.

In the embodiment shown in FIG. 1, the drawing system is designed such that a tandem arrangement of two cylinders (12) is provided. Initially, before the beginning of the actual drawing process, a primary cylinder (13) moves the drawing bar (11) into the area of the bottom (14) of the preform (1). During the actual drawing process, the primary cylinder (13) with the drawing bar extended is positioned together with a carriage (15) carrying the primary cylinder (13) by a secondary cylinder (16) or by a cam control system. In particular, consideration was given to the positioning of the secondary cylinder (16) by a cam control system such that an updated drawing position is determined by a guide roller (17), which moves along a cam track during the drawing process. The guide roller (17) is pressed by the secondary cylinder (16) against the guideway. The carriage (15) slides along two guide elements (18).

After the closing of the mold halves (5, 6) that are arranged in the area of supports (19, 20), the supports (19, 20) are locked relative to each other by means of a locking device (20).

For the adaptation to various forms of a lip segment (21) of the preform (1), according to FIG. 2, the use of separate thread inserts (22) in the area of the blow mold (4) is provided.

In addition to the blow-molded container (2), FIG. 2 also shows in dashed lines the preform (1), and schematically a container bubble (23) in the process of development.

For a general understanding of the technical context of the invention, FIG. 3 shows the basic structure of a blow-molding machine, which features a heating section (24) and a rotating blow wheel (25). Starting from the insertion (26) of a preform, the preforms (1) are transported by transfer wheels (27, 28, 29) to the area of the heating section (24).

Radiant heaters (30) and blowers (31) are arranged along the heating section (24) for the temperature control of the preforms (1). After the preforms (1) are sufficiently tempered, they are transferred to the blow wheel (25), in the area of which, for instance, the blowing stations (3) might be, as explained with respect to FIGS. 1 and 2. The finished blow-molded containers (2) are led by additional transfer wheels towards an output segment (32).

In order to be able to transform a preform (1) into a container (2) in such a way that the container (2) has the material properties for guaranteeing a long-term usability of food items filled into the container (2), and in particular of beverages, special process steps must be observed during the heating and orientation of the preform (1). Furthermore, advantageous effects may be accomplished through the observation of special dimensioning requirements.

By way of thermoplastic material, various synthetic materials may be used. Suitable materials include, for instance, PET, PEN, or PP.

The expansion of the preform (1) during the orientation process is accomplished by means of a supply of compressed air. The compressed air supply is divided into a pre-blowing phase, in which the gas, for instance compressed air, is supplied at a moderate pressure level, and a subsequent main blowing phase, in which the gas is supplied at a higher pressure level. During the pre-blowing phase, typically, compressed air is used with a pressure at intervals of 10 bar to 25 bar, whereas during the main blowing phase, compressed air at a pressure of 25 bar to 40 bar is supplied at intervals.

It can also be seen in FIG. 3 that in the shown embodiment, the heating section (24) comprises a plurality of rotating transportation elements (33), which are lined up in sequence and guided along diversion wheels (34). In particular, thought was given to creating an essentially rectangular base contour by the lined-up arrangement. In the embodiment shown, a single diversion wheel (34) of relatively large dimensions is used in the expansion area of the heating section (24) facing the transfer wheel (29) and an input wheel (35), and in the area of adjacent diversions, two diversion wheels (36) of relatively smaller dimensions are used. In principle, however, any other guides are conceivable as well.

In order to make possible the tightest possible arrangement of the transfer wheel (29) and the input wheel (35) relative to each other, the arrangement shown proves to be particularly expedient, since in the respective expansion area of the heating section (24), three diversion wheels (34, 36) are positioned, specifically, the smaller diversion wheels (36) in the area of the transfer to the linear progression of the heating section (24), and the larger diversion wheel (34) immediately in the area of the transfer to the transfer wheel (29) and to the input wheel (35). As an alternative to the use of sequentially lined-up transportation elements (33), it is also possible, for instance, to use a rotating heating wheel.

After the blow-molding of the containers (2) is completed, they are removed by an extraction wheel (37) from the area of the blowing stations (3) and transported to the output segment (32) by means of the transfer wheel (28) and the output wheel (38).

In the modified heating section (24) shown in FIG. 4, the larger number of radiant heaters (30) allows for the tempering of a larger quantity of preform (1) per time unit. The blowers (31) supply cooling air into the area of cooling air ducts (39), which are positioned across from respective radiant heaters (30), and which emit the cooling air via outflow vents. By means of the arrangement of the outflow directions, the flow direction of the cooling air is realized in a direction that is essentially traverse to a conveyance direction of the preforms (1). The cooling air ducts (39) may comprise reflectors for the radiated heat in the area of the surfaces facing the radiant heaters (30). It is also possible to accomplish the cooling of the radiant heaters (30) by means of the emitted cooling air.

The heating devices described above should also be understood as mere examples. From prior art, a plurality of alternative constructions is known: for instance, constructions embodied as heating wheels with single-location heating. In prior art, other heating methods are known as well, for instance the heating of preforms by microwave radiation. The invention is independent of the concrete features of the heating devices, and also independent of the heating method.

A preform (1) consists typically, and in accordance with the embodiment in FIG. 5, of a lip segment (52), of a support ring (54), also known as a neck ring, which separates the lip segment (52) from a neck area (53), of a shoulder area (56) which forms the transition from the neck area (53) to a wall segment (55), and of a bottom (57). The support ring (54) acts as a collar above the opening segment (52) transverse to a longitudinal axis (58) of the preform (1). In the region of the shoulder area (56), the external diameter of the preform (1) expands, starting from the neck area (53) in the direction of the wall segment (55). In a container (63) that will be manufactured from the preform (1), the wall segment (55) essentially forms the side walls of the container. The bottom (57) is shaped as a round.

The lip segment (52) may, for instance, feature an external thread (62), which makes it possible to install a screw-on lid on the completed container (63). It is also possible, however, to equip the lip segment (52) with an outer bulge in order to create an engagement surface for a crown cap. Furthermore, a plurality of additional designs is conceivable that allow the placement of plug caps. A plurality of standardized threadings is known. FIG. 17 shows an enlarged view of such a standardized thread (62).

It can be seen in FIG. 5 that the wall segment (55) features an inner surface (59) as well as an outer surface (60). The inner surface (59) delimits an interior space inside the preform (61)

In the shoulder area (56), the thickness of a preform wall (64) may extend along with an increasing wall strength, starting from the neck area (53) in the direction of the wall area (55). In the direction of the longitudinal axis (58), the preform (1) features a preform length (65). In the direction of the longitudinal axis (58), the lip area (52) and the support ring (54) extend with a joint finish length (66). In the area of the longitudinal axis of the container (58), the neck area (53) features a neck length (67). In the neck area (53), the preform (3) preferentially extends with a consistent wall thickness.

In the wall area (55), the preform (1) features a wall thickness (68), and in the bottom area (57), a bottom thickness (69) can be found. A further dimensioning of the preform (1) is accomplished by means of an interior diameter (70) and an exterior diameter (71), which can be measured in the nearly cylindrical wall area (55).

In the bottle-shaped container (63) shown in FIG. 6, the lip segment (52) and the support ring (54) can be found, essentially without any change. The other area of the container (63) was expanded relative to the preform (1) by the accomplished biaxial orientation in the traverse direction as well as in the longitudinal direction. The container (63) therefore has a container length (72) and a container diameter (73) for which, in view of the exactness required, no differentiation should be made below between the concrete internal diameter and the concrete exterior diameter, respectively.

FIG. 6 shows, among other things, the bottom area of the blow-molded container (63). The container (63) features a side wall (74) and a container bottom (75). The container bottom (75) consists of a base ring (76) and a heel (78), which sweeps inward into the interior of the container (77). The heel (78) consists of a heel incline (79) and a center (80).

The container (63) features a container finish length (81) and a container neck length (82), wherein at least the container finish length (81) is generally equal to the finish length (66) of the preform (1).

The heating of the preform (1) before the orientation process is conceivable in several variations. When a tunnel-shaped heating section is used, temperature control is solely dependent on the length of the stay. It is also conceivable, however, that radiant heaters be used, which act on the preform (1) with infrared or high frequency radiation. With the help of such radiators, it is possible to generate a temperature profile in the area of the preform (1) in the direction of the longitudinal axis (58) or in the radial direction of the circumference.

If such a radiant heater is formed by multiple heating elements that can be controlled independently from each other, and which are arranged above each other in the direction of the longitudinal axis (58), a more intensive activation of the heating elements in the area of the upper expansion of the preform (1) in the direction of the lip segment (52) allows for the radiation of a higher heat energy in the thicker area of the wall segment (55) than in the area of the wall segment (55) that faces the bottom (7). With radiant heaters that can only be uniformly controlled, such a heat profiling can also be accomplished by way of an arrangement of the heating elements at different intervals in the direction of the longitudinal axis (58).

FIG. 7 shows a cross-section through a container (63) with a non-circular cross-section in the form of an oval. Therefore, this is not a consistent container diameter (73), but rather, the container diameter (73) ranges between a minimum container diameter (83) and a maximum container diameter (84), depending on the direction of measurement. In the embodiment according to FIG. 7, the lip segment (52) of the container (63) is essentially arranged centrically.

In the embodiment according to FIG. 8, the container (63) features a design similar to that of the container (63) according to FIG. 7. The lip segment (52), however, is placed at an offset as compared to the center line of the container (85).

FIG. 9 shows a horizontal section through a preform (1) arranged in the area of a heating device (86). It can be seen that the heating device (86) features a radiant heater (87) and a reflector (88). In this embodiment, a circumference (89) of the preform (1) is divided into four angular areas (90, 91, 92, 93). In the radial direction of the circumference (89), a different tempering of the angular areas (90, 91, 92, 93) is desired. In order to produce a container (63) with a contour according to FIG. 7, it is expedient, for instance, that the angular areas (90, 92) and the angular areas (91, 93) be tempered at least approximately identically. In particular, it is envisaged that the angular areas (90, 92) be provided with a higher temperature than the angular areas (91, 93) when an oval container (63) is to be produced. The size of the respective angular areas (90, 91, 92, 93) depends on the form of the container (63) that is to be blow-molded.

In order to obtain the temperature profile in the radial direction of the circumference (89), it is possible, for instance, to perform a step-wise rotation of the preform (1) around its longitudinal axis (58), as illustrated in FIG. 10 against a time axis (94). Short movement segments (95) alternate with resting segments (96). With temperature profiling in the radial direction of the circumference with four angular areas (90, 91, 92, 93), the movement may be such that initially, within a predefinable resting segment (96), the angular area (90) faces the heating device (86), and that after the end of the resting segment (96), within the movement segment (95), the angular area (91) is led past the heating device (86) at a relatively high speed. At the end of the movement segment (95), the angular area (92) will be facing the heating device (86). This involves a rotation of the preform (1) by approximately 180°.

It is possible, for instance, to initially temper the preform (1) uniformly, and then generate the temperature profile by means of the movement described above. It is also possible to design the movement of the preform (1) during its rotation such that, departing from a cold preform (1), the respective movement phases achieve the temperature profile. At least in temperature profiling that comes after pretempering, the movement segments (95) are materially shorter than the resting segments (96). The ratio between the durations might be 1:10.

FIG. 11 shows an additional possibility for applying a temperature profile. A pretempered preform (1) is moved in steps past the cooling nozzle (103) which emits a cooling gas. For instance, air may be used.

In the embodiment according to FIG. 12, the preforms (1) are moved past heating devices (86) which are positioned across from each other on opposite sides of the transportation trajectory. In this case, no rotation of the preforms (1) is envisioned. Rather, the stepped heating is realized by way of successive heating zones on each side of the transportation trajectory. Due to their intermittent arrangement across from each other, the heating devices are prevented from radiating at each other. However, the use of appropriate cooling also makes it possible to achieve an arrangement [of heating devices] across from each other, or an arrangement in which they are across from each other at an offset, and partially overlapping.

FIG. 13 shows a further variant. The preforms (1) are moved here in the transportation direction (104) as well as in a rotational direction (105). The heating devices (86) are linked to a heat controller (106) which activates the heating devices (86) lined up behind each other in the transportation direction (104) such that they generate the desired temperature profile on the preforms (1) that are moving past them. In this embodiment, it is expedient to use heating devices (86) of relatively small dimensions in the transportation direction (104) in order to support accurate temperature specifications.

After being filled, the finished blow-molded container (2) must receive a cap. If the orientation of the cap relative to the blow-molded container (2) is uncritical, it is also uncritical how the preform (1), or rather, of the thread (62) of the preform (1), is oriented during the inhomogeneous heating process. If the blow-molded container (2) is rotationally symmetric with its longitudinal axis (58), the orientation of the thread during the application of the temperature profile in the heating section (24) is uncritical as well. This changes, however, when the cap must be aligned in a prespecified way relative to a finished blow-molded rotationally non-symmetric container (2), for instance, when the blow-molded container (2) features an oval cross-section, that is, when it features a preferential predetermined alignment according to which the cap must be positioned on it. This is known, for instance, from spray bottles with caps with spray nozzles for manual operation. In such cases, it is often desired that the manual actuating device is positioned in a specific direction with respect to the bottle of the spray bottle.

FIG. 14 shows a perspectival view and a cross-sectional view of a preform (1) held by a conveyor mandrel (9) with an alignment element (140) according to a first embodiment, whereas FIG. 15 views analogous to FIG. 14 of a second embodiment. Since the two variants differ only in terms of their alignment elements (140, 150), which engage different structures of the otherwise identical designed thread (62), and which are also otherwise identically designed, these two figures should be described together, before the respective differences between are described.

According to the exemplary embodiment of FIG. 14, the preform (1) is held by a conveyor mandrel (9) with its lip area pointing downward. On its lower end, this conveyor mandrel (9) features an eccentrically positioned alignment pin (141), which is used for the alignment of the conveyor mandrel (9), as will be explained below in the context of FIG. 16. The conveyor mandrel (9) further features a cog wheel (142), which radially extends beyond the rest of the area of the conveyor mandrel (9), and which may serve, for instance, for the transportation of the mandrel (9) and may interact with a conveyor chain.

The thread of the preform (1) is an example of a standard thread, specifically, a thread referred to as PCO 1881, an enlarged view of which is shown in FIG. 17. Among other things, this thread features so-called venting slots (143), which can be seen in particular in the cross-sectional view in the left half of the illustration of FIG. 14, and in FIG. 17. In total, four venting slots (143) can be seen here, which extend in the longitudinal direction (58) of the preform (1) along the entire length of the thread, in order to allow for aeration when a screw-on lid is screwed off. The venting slots (143) are delimited by lateral surfaces of the thread pitches (173) that are interrupted by the venting slots (143). These lateral surfaces are suitable contact surfaces. As soon as the alignment element (140) is brought into contact with such a lateral surface, the rotation of the preform (1) is no longer possible. To the extent the conveyor mandrel (9) should continue to rotate, the alignment element (140) will keep the preform (1) in place, allowing the conveyor mandrel (9) to rotate relative to the stationary preform (1). Until this contact was established, the preform (1) rotates together with the mandrel (9).

The alignment element (140) is preferentially designed as a radial spring, and the part of it that engages the thread (62) of the preform features a narrow engagement blade, which is dimensioned such that it can be injected between two adjacent thread pitches (173), pushing against a lateral surface of a venting slot (143) when the preform (1) reaches a certain alignment position.

The alignment element (150) in FIG. 15 is designed analogously. In this second embodiment variant, only the thread runout (171) serves as a contact surface for the alignment element (150). The alignment element (150) further features in the area that engages the thread (62) of the preform two small blades that are spaced above each other. Between these two blades there is a recess along which the thread pitches (173) of the thread (62) of the preform (1) can slide until the blades come into contact with the thread runout (171). At this point, the rotation of the preform (1) is arrested, so that while, for instance, a rotating mandrel (9) may continue to rotate, the preform (1) will remain in the alignment position that it has reached. In a further analogous manner, the thread intake (172) may serve as a contact surface for the alignment element (150) as well.

For further explanations on the alignment of the preform (1) and the conveyor mandrel (9) we refer to FIG. 16, which shows an enlarged view of the intake area of a heating section (24) with alignment elements for conveyor mandrels (9) and for preforms (1). In the intake area shown in FIG. 16, the conveyor mandrels (9) with the preforms (1) positioned on them are taken in. An underlying alignment rail (160) with a recess (161) tapering off toward in the transportation direction ensures that the mandrels (9) are aligned by means of the alignment pins (141, 151) designed for that purpose. The alignment wheel (165) features alignment elements (166) which can be radially pivoted by cam control. The mandrels (9) are rotationally driven, and the alignment elements (166) are radially pivoted when the alignment wheel (165) reaches a certain rotational position, such that they engage with the thread area of the preform (1). The conveyor mandrel (9) and the preform (1) held by it will rotate until the alignment element (166) comes into contact with a predefined contact surface of the thread (62). According to the embodiment variants in FIG. 14 and FIG. 15, this might, for instance, be a venting slot (143) or a thread runout (171) or a thread intake (172). The alignment wheel (165) may be positioned upstream from the heating section (24), or be part of the heating section (24) itself. At the end of the alignment process, the thread (62) of the preform (1) and the alignment pin (141) of the mandrel (9) are aligned in a predefined desired position relative to each other. If, for instance, the conveyor mandrel (9) is designed as a clamping device, the clamping force must be dimensioned such that during a failure-free operation of the machine, the preform (1) is held in place relative to the mandrel (9) in the desired position. The conveyor mandrel (9) and the preform (1) may then be transported as a single entity through the blow-molding machine, such that, for instance, the alignment pin (141) of the mandrel (9) may be used for the alignment of the thread (62) of the preforms (1). Preferentially, the conveyor mandrel (9), together with the preform (1) held by it, will not only travel through the heating section (24), but it will also travel with it to the blowing station (3), and might, for instance, also serve advantageously inside the blowing station (3). The conveyor mandrel (9) and the preform (1) held by it might then be separated before the exiting from the blowing station (3), for instance. However, it is also possible, for instance, that the conveyor mandrel (9) travels together with the finished blow-molded container (2) to a filling machine positioned further downstream.

FIG. 17 shows in the lower cross-section that the respective contact areas (venting slots, thread intake, thread runout) are generally designed at an angle to the surface normal (174) of the cylindrical base form of the preform (1). The example of the thread runout (171) shows that an incline is generally envisioned at an angle α. The thread intake (172) and the thread runout (171) are further defined by the radii R1 and R2, and by a height h.

Preferentially, these dimensions are related to each other in a certain manner, for instance in that R1 and/or R2 are smaller than ½ of h, and further preferentially, smaller than ⅓ of h. This is preferential for every standard thread, independent of the concrete thread type. Furthermore, for every thread type, it is preferred that between the radii R1 and R2 there be a linear edge area I, preferentially, I being greater than 10% of h, and further preferentially, greater than 20%, and even further preferentially, greater than 30%.

1. A method for heating a preform that is rotationally symmetric about a longitudinal axis of the preform, has a standard thread, and is made of a thermoplastic material such that the preform is temperature conditioned to be formed into a container having a non-circular cross-section transverse to a longitudinal axis of the container by blow-molding shaping, the method comprising steps of:
providing the preform with a temperature profile along a circumference of the preform during heating, which temperature profile is generated such that areas of the preform are differentially heated in a radial direction of the circumference of the preform; and
aligning the standard thread of the preform in a predefined target position before said areas of the preform are differentially heated;
wherein the preform is rotated in the aligning step, and
wherein, during the aligning step, an alignment element engages in the standard thread of the preform and thereby prevents further rotation of the preform as soon as the alignment element comes in contact with a predetermined contact surface in the standard thread.

2. The method according to claim 1, wherein the alignment element engages in at least one venting slot of the standard thread, and wherein the predetermined contact surface is the venting slot.

3. The method according to claim 1, wherein the predetermined contact surface is a thread runout and/or a thread intake of the standard thread.

4. The method according to claim 1, wherein the preform is transported through a heating section of a blow-molding machine for heating, and wherein on at least part of its way through the heating section the preform is held by a carrier element which travels together with the preform, wherein during transport through the heating section, the carrier element is also aligned, and wherein the aligned carrier element and the aligned preform are transported jointly to a blowing station while maintaining their relative alignment until an end of the heating section.

5. The method according to claim 4, wherein the carrier element is a conveyor mandrel.

6. The method according to claim 4, wherein the preform is rotated by rotating the carrier element.

7. The method according to claim 1, wherein the predetermined contact surface is arranged at an angle α to a surface normal of a surface of the preform, wherein α is smaller than 60°.

8. The method according to claim 1, wherein the alignment element engages in at least a pair of venting slots of the standard thread, and wherein the predetermined contact surface is the pair of venting slots.

9. The method according to claim 2, wherein the alignment element is dimensioned and arranged such that the predefined contact surface is only one venting slot.

10. The method according to claim 8, wherein the alignment element is dimensioned and arranged such that the predefined contact surface is two or more venting slots.

11. The method according to claim 7, wherein α is smaller than 45°.

12. The method according to claim 7, wherein α is smaller than 30°.
